(19) United States
(12) Patent Application Publication
(10) Pub. No.: US 2012/0286100 A1
(43) Pub. Date: Nov. 15, 2012

(54) Device for Trapping Space Debris

(75) Inventor: Ulrich KNIRSCH, Markdorf (DE)

(73) Assignee: Astrium GmbH, Taufkirchen (DE)

(21) Appl. No.: 13/465,130

(22) Filed: May 7, 2012

(30) Foreign Application Priority Data
May 9, 2011 (DE) 10 2011 100 971.3

(51) Int. Cl. B64G 1/66

(52) U.S. Cl. 244/172.6

(57) ABSTRACT

A device for trapping space debris with at least one rope-like trap for space debris is provided. The trap includes an end piece configured for being wound around space debris or parts thereof. The rope-like trap is further configured in such a manner that upon contact with the space debris, it can generate a friction that is sufficient for towing the space debris.

### CROSS-REFERENCE TO RELATED APPLICATIONS

The present application claims priority under 35 U.S.C. §119 to German Patent Application No. 10 2011 100 971.3, filed May 9, 2011, the entire disclosure of which is herein expressly incorporated by reference.

### BACKGROUND AND SUMMARY OF THE INVENTION

Exemplary embodiments of the present invention relate to a device for trapping space debris.

Due to the increasing utilization of space, a lot of space debris or junk is produced, for example by non-functional satellites, burnt out rocket stages and satellite and rocket fragments. Due to the usually high speed differences between debris and functional objects (e.g., satellites or space stations), such space debris poses a great danger because due to the high speeds, even small parts can have a very high kinetic energy so that during the impact, considerable damage can be done in some cases.

In order to avoid space debris, space vehicles, such as satellites, are usually configured such that they “dispose” themselves at the end of their service life, for example, bring themselves automatically into an unused orbit (so-called graveyard orbit) or decelerate like rocket engine stages in order to burn up in the Earth's atmosphere. However, in the case of defects, space vehicles that are no longer used can remain in the orbit and can pose there a risk of collision for the functional space vehicles. For example, an operating satellite can collide with a defective satellite that can no longer be utilized and controlled, which produces even more space debris in the orbit concerned.

Particularly in lower orbits, it is efficient to crash rather large parts of space debris or junk such as, for example, satellites so that they burn up when entering the Earth's atmosphere. In order to be able to initiate such crash maneuvers, so-called “tow satellites” are investigated which, for example, move into close vicinity to a defective satellite and has to dock there on an engine jet or the like. Docking is particularly technically complex because standardized adaptors do not exist for this purpose. Moreover, the maneuver is extremely critical for the tow satellite because it has to be assumed that the defective satellite rotates or even tumbles, and during the approaching and docking maneuver, the danger of a collision, which absolutely must be avoided, therefore increases.

Exemplary embodiments of the present invention provide a refined device for trapping space debris that is primarily suited for trapping tumbling or rotating space debris, in particular without assistance of the space debris.

In accordance with exemplary embodiments of the present invention, the space debris is trapped with a rope-like trapping means that is wound around the debris and upon contact with the space debris generates a friction that is high enough that the debris can be towed. By utilizing the friction generated by the rope-like trapping means according to the invention in contact with the debris, the debris trapped in this manner, for example, can be towed by a tow satellite and transported to a graveyard orbit or can be crashed. With the aid of the invention, it is possible to trap tumbling or rotating space debris without requiring, for example, a tow satellite to come so close to the debris that there is the risk of a collision. The device according to the invention has also the advantage that it can principally be used for a plurality of trapping attempts, i.e., it permits not only one attempt, but can be configured in a reversible manner. Also, it can be configured such that it can be used for a plurality of successive trapping and towing missions of space debris. Furthermore, said device can be produced in a comparatively simple and cost-effective manner and has a relatively low mass which is principally of great advantage for space missions.

One embodiment of the invention relates to a device for trapping space debris with at least one rope-like trapping means for space debris that has an end piece configured for being wound around space debris or parts thereof, wherein the rope-like trapping means is further configured in such a manner that upon contact with the space debris, it can generate a friction that is sufficient for towing the space debris. For example, the device can have one or two rope pulleys by means of which trapping ropes with a high friction coefficient for space debris and with special end pieces can be wound up and unwound.

The rope-like trapping means can have such a low flexural stiffness that the friction necessary for towing the space debris can be generated. Furthermore, the rope-like trapping means can have a friction coefficient that is high enough that the static friction force acting on the space debris is greater than a predetermined towing force. The rope-like trapping means can also have additional adhesive agents, in particular bonding materials, for generating a friction that is sufficient for towing the space debris.

The device can further be configured for setting the at least one rope-like trapping means for space debris in rotation. Hereby, when impinging on space debris, the rotating rope-like trapping means can wind around said debris.

The device can further include cutting means for cutting through at least one rope-like trapping means for space debris. For example, as cutting means, cutting knives can be used that prior to a final crash, for example of a towed satellite, cut the rope-like trapping means.

The device can further be configured for retracting and extending the at least one trapping means for space debris. Hereby, a trapping range can be set, whereby the device can be adapted to different kinds of space debris, for example, the trapping means extends farther outward in the case of rotating satellites having large solar sails, or extends less in the case of rather small debris parts such as satellite fragments.

Another embodiment of the invention relates to a satellite for trapping and towing space debris with at least one device according to the invention and as described above. Such a satellite can be designed as a tow satellite for a plurality of trapping missions, the satellite including adequate control possibilities and trapping means sufficiently dimensioned for these missions.

The satellite can have two of the devices according to the invention which are attached on opposite sides of the satellite.

Furthermore, the satellite can be configured to be set into rotation about an axis in such a manner that the rope-like trapping means of the at least one device also rotates about the axis.

Further advantages and possibilities of use of the present invention arise from the following description in connection with the exemplary embodiments illustrated in the drawings.

### BRIEF DESCRIPTION OF THE DRAWING FIGURE

In the description, in claims, in abstract and drawings, the terms and/or associated reference numbers used in the reference list below are used.

In the figure:

FIG. 1 schematically illustrates a tow satellite according to the invention, the satellite having a trapping device for space debris according to the invention that is used for trapping a rotating defective satellite.

### DETAILED DESCRIPTION

In the following description, identical, functionally identical and functionally related elements can be designated with the same reference numbers. Absolute values are given only exemplary in the following and are not to be understood as limiting the invention.

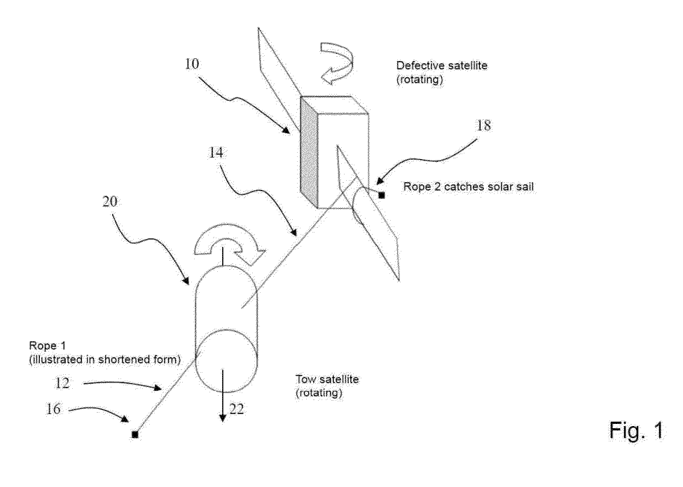

FIG. 1 schematically illustrates how a defective and rotating satellite 10 having solar sails is trapped so it can be towed by a tow satellite 20 according to the invention. For this purpose, the tow satellite 20 approaches the defective satellite only as close as necessary so that there is no danger of a collision, for example with the solar sails, but close enough that the defective satellite 10 is within the trapping range. This approaching maneuver is controlled from a control center from the earth or from a space vehicle such as a space station.

As soon as the tow satellite 20 is navigated into a trapping position, trapping devices, for example in the form of rope pulleys, attached on two opposite sides of the structure of tow satellite 20 are controlled in such a manner that the rope-like trapping means 12 and 16 wound on said pulleys extend far enough that the end pieces 14 and 18 (in FIG. 1 illustrated by a point at the end of the rope) of the rope-like trapping means 12 and 16 reach up to the defective satellite 10.

The rope-like trapping means 12 and 16 are configured such that they can produce such a high friction in contact with a part of the satellite 10 that the satellite 10 can be towed by the tow satellite 20. In order to achieve this friction, the rope-like trapping means 12 and 16 are ropes having a low flexural stiffness and/or have a friction coefficient that can generate a static friction force on the defective satellite 10 that is higher than a towing force necessary for towing the satellite 10. Also, additionally or alternatively, the rope-like trapping means 12 and 16 can have adhesive agents for generating a friction of the end pieces on the satellite that is sufficient for towing. The adhesive agents can comprise, for example, bonding materials such as chemicals used as a binder (e.g., an adhesive) or mechanical means (e.g., barbs). Thus, adhesive agents in the meaning of the invention are all means which serve for increasing the friction between the rope-like trapping means 12 and 16 and a part of the defective satellite 10 in addition to the static friction that occurs already between the rope-like trapping means 12 and 16 and the satellite 10 during trapping.

After extending the rope-like trapping means 12 and 18, the tow satellite 20 is set in rotation about its axis 22, whereby the extended trapping means 12 and 18 rotate as well. Due to the centrifugal force, the end pieces 14 and 18, which have a mass sufficient for being wrapped around space debris, move away from the tow satellite 20 and tension the extended trapping means 12 and 16. The tensioned trapping means 12 and 16 can now trap the defective satellite 10 in that upon contact with a part of the satellite 10 such as the solar sail, the end pieces 14 and 18, due to their mass, wrap the rope-like trapping means 12 and 16, respectively, around said part. In FIG. 1 it is illustrated how the second rope-like trapping means 16 is wrapped with its end piece 18 around the solar sail of the defective satellite 10.

Instead of a rotation of the tow satellite 20, it is also conceivable to provide a special rotating device on the tow satellite, which device sets only the trapping devices in rotation in such a manner that the extended rope-like trapping means 12 and 16 rotate.

As soon as a part of the defective satellite 10 is wrapped by a rope-like trapping means 14, the rotation of the tow satellite 20 is stopped, and free trapping means, i.e., trapping means which are not wound around the defective satellite 10, such as the first trapping means 12, are wound onto the rope pulley of the trapping device.

Then, the towing maneuver is started in that the tow satellite 20 tows the defective satellite 10 to a graveyard orbit or toward the surface of the Earth for a crash. As soon as the graveyard orbit or the crash position is reached, the second trapping means 14 is cut using cutting knives of the respective trapping device that cut through the rope-like trapping means 12. Thereby, the connection between the tow satellite 20 and the defective satellite 10 is disconnected, whereby the latter is left to its fate.

The tow satellite 20 can now be navigated to a further towing mission.

The invention enables trapping of space debris by means of a flexible connection to the debris, whereby the danger of a collision between the trapping device and the debris can be reduced. In addition, during towing, the center of gravity of the space debris positions itself automatically along the thrust axis so that the engine control is simplified, in particular with respect to stiff connections.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE LIST

10 Defective rotating satellite (space debris)
12 First rope-like trapping means
14 End piece of the first rope-like trapping means
16 Second rope-like trapping means
18 End piece of the second rope-like trapping means
20 Towing satellite
22 Axis of rotation of the towing satellite

What is claimed is:

1. A device for trapping space debris, comprising:
a structure; and
at least one rope-like trapping means for space debris that is connected to the structure,
wherein the at least one rope-like trapping means comprises an end piece configured to be wound around a portion of the space debris and is configured in such a manner that upon contact with the space debris, it can generate a friction that is sufficient for towing the space debris.

2. The device according to claim 1, wherein the at least one rope-like trapping means has such a low flexural stiffness that the friction sufficient for towing the space debris can be generated.

3. The device according to claim 1, wherein the at least one rope-like trapping means has such a high friction coefficient that the static friction force acting on the space debris is higher than a predetermined towing force.

4. The device according to claim 1, wherein the at least one rope-like trapping means has bonding materials that generate a friction sufficient for towing the space debris.

5. The device according to claim 1, wherein the device is configured for setting the at least one rope-like trapping means for space debris into rotation.

6. The device according to claim 1, further comprising:
cutting means for cutting through the at least one rope-like trapping means for space debris.

7. The device according to claim 1, wherein the device is configured for extending or retracting the at least one rope-like trapping means for space debris.

8. The device according to claim 1, wherein the device is a satellite.

9. The device according to claim 8, wherein the satellite has two rope-like trapping means that are attached on opposite sides of the satellite.

10. The device according to claim 9, wherein the device is configured for being set in rotation about an axis in such a manner that the at least one rope-like trapping means of the device also rotates about said axis.

11. A satellite, comprising:
a structure; and
a rope-like trap, attached to the structure, with an end piece configured to be wound around a portion of the space debris, wherein the rope-like trap is configured in such a manner that upon contact with the space debris, it generates a friction sufficient for towing the space debris.

12. The satellite according to claim 11, wherein the rope-like trap has such a low flexural stiffness that the friction sufficient for towing the space debris can be generated.

13. The satellite according to claim 11, wherein the rope-like trap has such a high friction coefficient that the static friction force acting on the space debris is higher than a predetermined towing force.

14. The satellite according to claim 11, wherein the rope-like trap has bonding materials that generate a friction sufficient for towing the space debris.

15. The satellite according to claim 11, wherein the device for trapping space debris is configured for setting the rope-like trap into rotation.

16. The satellite according to claim 11, further comprising:
a cutting device configured to cut through the rope-like trap.

17. The satellite according to claim 11, wherein the device for trapping space debris is configured for extending or retracting the rope-like trap.
